(19) United States
(12) Patent Application Publication
(10) Pub. No.: US 2010/0120345 A1
(43) Pub. Date: May 13, 2010

(54) FRESH AIR BOX

(76) Inventors: Aidan Ryan, Shanghai (CN); Grace Deng, Shanghai (CN); Hailin Gong, Shenzhen (CN)

Correspondence Address: MICHAEL BEST & FRIEDRICH LLP, 100 E WISCONSIN AVENUE, Suite 3300, MILWAUKEE, WI, 53202, US

(21) Appl. No.: 12/613,999

(22) Filed: Nov. 6, 2009

(30) Foreign Application Priority Data
Nov. 7, 2008 (CN) 200810174484.6

(51) Int. Cl. B60H 1/00; B60H 3/00

(52) U.S. Cl. 454/75; 454/136; 454/156

(57) ABSTRACT

A rooftop temperature control unit for a vehicle having a conditioned space includes a housing defining a plenum and including an air inlet. The plenum is configured to receive an inflow of outdoor air from outside of the vehicle through the air inlet. The outdoor air defines an outdoor air temperature. A heat exchanger assembly is coupled to the housing and in fluid communication with the plenum. The heat exchanger assembly is configured to receive a first portion of the outdoor air from the plenum, to cool the first portion to a temperature below the outdoor air temperature, and to discharge the cooled first portion into the conditioned space. A blower is configured to receive a second portion of the outdoor air from the plenum and to discharge the second portion into the conditioned space at a temperature equal to or greater than the outdoor air temperature.

### BACKGROUND

The present invention relates to a rooftop temperature control unit for a vehicle, in particular a bus.

Typical rooftop temperature control units for busses provide cooling to a conditioned space, or cabin, within the bus. A heat exchanger within the temperature control unit cools return air, which is directed back to the conditioned space. Some rooftop temperature control units include an opening through which fresh outdoor air enters the temperature control unit by natural flow to be cooled by the heat exchanger. The introduction of fresh air improves air quality in the conditioned space, but the natural flow of the fresh air is difficult to control.

### SUMMARY

In one embodiment, the invention provides a rooftop temperature control unit for a vehicle having a conditioned space. The rooftop temperature control unit includes a housing defining a plenum and including an air inlet. The plenum is configured to receive an inflow of outdoor air from outside of the vehicle through the air inlet. The outdoor air defines an outdoor air temperature. A heat exchanger assembly is coupled to the housing and in fluid communication with the plenum. The heat exchanger assembly is configured to receive a first portion of the outdoor air from the plenum, to cool the first portion to a temperature below the outdoor air temperature, and to discharge the cooled first portion into the conditioned space. A blower is coupled to the housing and in fluid communication with the plenum, the blower configured to receive a second portion of the outdoor air from the plenum and to discharge the second portion into the conditioned space at a temperature equal to or greater than the outdoor air temperature.

In another embodiment, the invention provides a method of operating a rooftop temperature control unit for a vehicle having a conditioned space. The method includes receiving an inflow of outdoor air from outside of the vehicle through an air inlet of a housing and into a plenum defined by the housing, receiving with a heat exchanger assembly a first portion of the outdoor air from the plenum, cooling with the heat exchanger assembly the first portion to a temperature below an outdoor air temperature, discharging with the heat exchanger assembly the cooled first portion into the conditioned space, receiving with a blower a second portion of the outdoor air from the plenum, and discharging with the blower the second portion into the conditioned space at a temperature equal to or greater than the outdoor air temperature.

Other aspects of the invention will become apparent by consideration of the detailed description and accompanying drawings.

### BRIEF DESCRIPTION OF THE DRAWINGS

FIG. 1 is a perspective view of a bus having a rooftop temperature control unit embodying the invention.

FIG. 2 is an exploded perspective view of the temperature control unit of FIG. 1.

FIG. 3 is an exploded perspective view of a second construction of the temperature control unit of FIG. 1.

FIG. 4 is a perspective view of a fresh air compartment of the temperature control unit of FIG. 1.

FIG. 5 is a cross section of the fresh air compartment taken along line 5-5 of FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

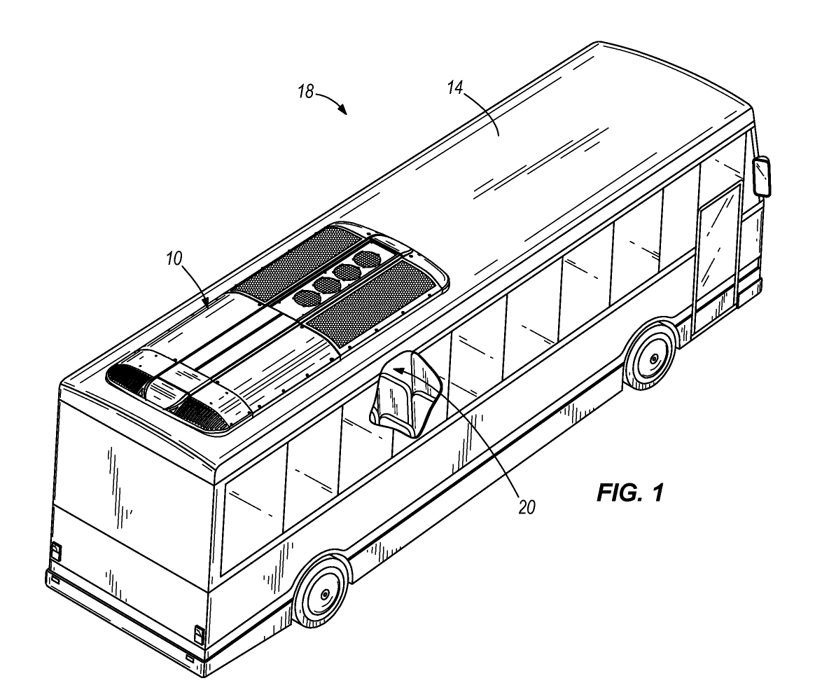

FIG. 1 illustrates a temperature control unit 10 embodying the invention mounted to the rooftop 14 of a bus 18. The temperature control unit 10 communicates with a conditioned space 20 inside the bus 18 by providing temperature-controlled air to the conditioned space 20. It is to be understood that the temperature control unit 10 may be employed in any vehicle, but is preferably employed in a bus. Furthermore, the temperature control unit 10 may be mounted to any portion of the vehicle and is not limited to being mounted on the roof 14.

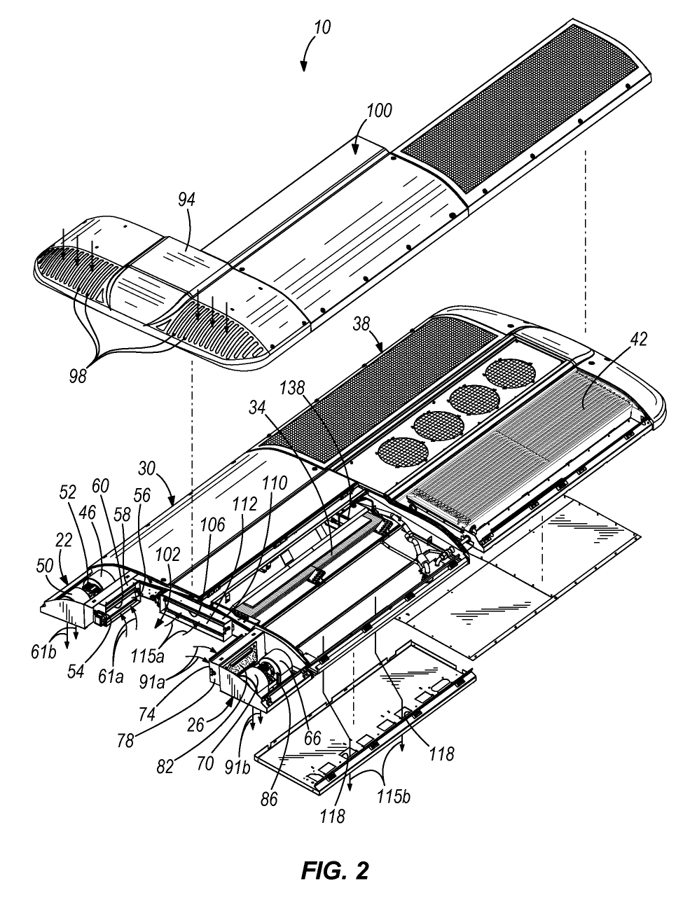

FIG. 2 is an exploded view of a first construction of the temperature control unit 10. The temperature control unit 10 includes a first compartment or fresh box 22, a second compartment or fresh box 26, an evaporator compartment 30 containing an evaporator 34 and an evaporator blower (not shown), and a condenser compartment 38 containing a condenser 42. An evaporator assembly includes the evaporator compartment 30 housing the evaporator 34 and evaporator blower. The evaporator 34 and the condenser 42 belong to an air conditioning system (not shown in its entirety) including a compressor, expansion modules and fluid conduits forming a refrigeration circuit, as is commonly known in the art. Therefore, the air conditioning system will not be explained in further detail.

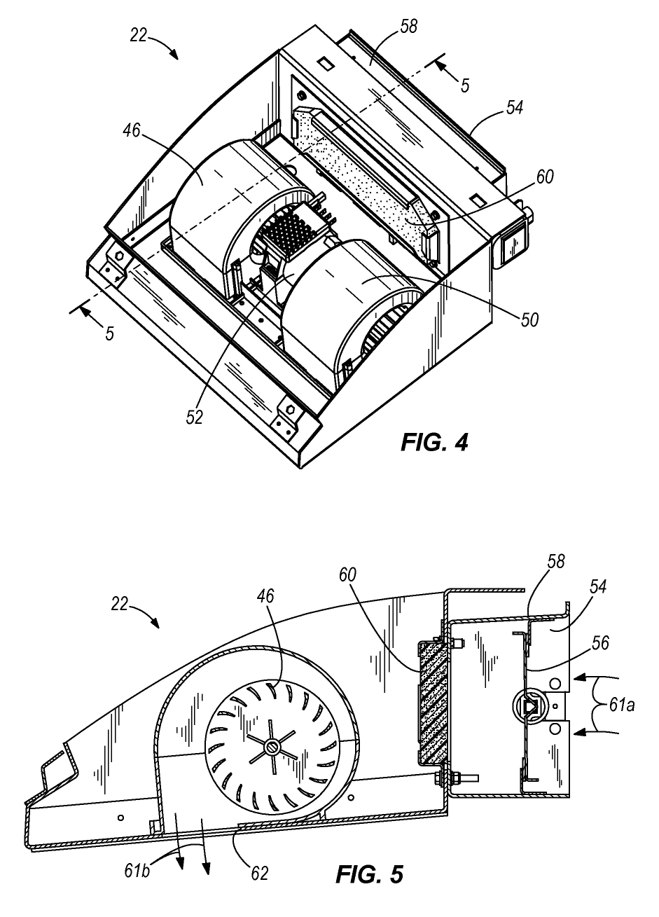

With reference to FIG. 4, the first compartment 22 contains first and second blowers 46, 50 and includes a first compartment inlet 54 and a first compartment damper 58 coupled to the first compartment inlet 54. The first compartment damper 58 includes a moveable plate 56 to adjust the inflow of air to the first compartment 22 through the first compartment inlet 54. A first dust filter 60 is coupled to the first compartment inlet 54 and is positioned substantially within the first compartment 22 to filter the inflow of air into the first compartment 22. The first and second blowers 46, 50 are coupled to a first motor 52 for synchronized rotation with the first motor 52. The motor 52 preferably runs at multiple speeds to operate the blowers 46, 50 at multiple speeds. For example, the motor 52 may run the blowers 46, 50 at a high speed, a low speed and off. Preferably, the motor 52 runs the blowers 46, 50 at a plurality of non-zero speeds. In other constructions, the first compartment 22 may contain fewer or more blowers and the blowers may be coupled to separate motors for separately controlled rotation. In the illustrated construction, the first and second blowers 46, 50 are centrifugal fans. In other constructions, other types of blowers, such as fans and other devices that move air, may be employed. Also in other constructions, the first dust filter 60 may be positioned substantially outside of the first compartment 22 or just partially within the first compartment 22.

FIG. 5 is a cross-section of the first compartment 22 through the first compartment inlet 54 and the first blower 46. The inflow and outflow of air through the first compartment 22 is indicated by arrows 61a, 61b. Air enters the first compartment 22 through the first compartment damper 58 and passes through the first compartment inlet 54 and the first dust filter 60. The first dust filter 60 substantially prevents dust and debris from entering the first compartment 22. The air is then drawn by the first blower 46 and the second blower 50 (FIG. 4) and directed through a first compartment outlet 62 into a bus duct (not shown) and into the conditioned space 20. The air drawn into and expelled from the first compartment 22 and into the conditioned space 20 is at a temperature equal to or greater than the outdoor air temperature. In other words, outdoor air is drawn into the plenum 102, drawn into the first compartment 22 and discharged to the conditioned space 20 without passing through a heat exchanger for cooling the outdoor air. The direction of the outflow 61b from the first compartment 22 is substantially perpendicular to the direction of the inflow 61a to the first compartment 22.

It is to be understood that the second compartment 26 is substantially identical to the first compartment 22 in the illustrated construction. However, different reference numerals are used in FIG. 2 to distinguish the first compartment 22 from the second compartment 26. Although FIGS. 4-5 are labeled with reference numerals corresponding to the first compartment 22, the description of FIGS. 4-5 above could be used to describe the second compartment 26 as well. Therefore, separate figures including reference numerals corresponding to the second compartment 26 will not be provided as it is to be understood that the description above of the first compartment 22 with respect to FIGS. 4-5 can be applied to the second compartment 26. However, the first and second compartments 22, 26 may be constructed differently and still fall within the scope of the invention.

With reference to FIG. 2, the second compartment 26 contains third and fourth blowers 66 and 70, respectively, and includes a second compartment inlet 74 and a second compartment damper 78 coupled to the second compartment inlet 74. The second compartment damper 78 includes a moveable plate 80 to adjust the inflow of air to the second compartment 26 through the second compartment inlet 74. A second dust filter 82 is coupled to the second compartment inlet 74 and is positioned substantially within the second compartment 26 to filter the inflow of air into the second compartment 26. The third and fourth blowers 66, 70 are coupled to a second motor 86 for synchronized rotation with the second motor 86. The motor 86 preferably runs at multiple speeds to operate the blowers 66, 70 at multiple speeds. For example, the motor 86 may run the blowers 66, 70 at a high speed, a low speed and off. Preferably, the motor 86 runs the blowers 66, 70 at a plurality of non-zero speeds. In other constructions, the second compartment 26 may contain fewer or more blowers and the blowers may be coupled to separate motors for separately controlled rotation. In the illustrated construction, the third and fourth blowers 66, 70 are centrifugal fans. In other constructions other types of blowers, such as fans and other devices that move air, may be employed. Also in other constructions, the second dust filter 82 may be positioned substantially outside of the second compartment 26 or just partially within the second compartment 26.

The inflow and outflow of air through the second compartment 26 is indicated by arrows 91a, 91b. Air enters the second compartment 26 through the second compartment damper 78 and passes through the second compartment inlet 74 and the second dust filter 82. The second dust filter 82 substantially prevents dust and debris from entering the second compartment 26. The air is then drawn by the third blower 66 and the fourth blower 70 and directed through a second compartment outlet 90 into a bus duct (not shown) and into the conditioned space 20. The air drawn into and expelled from the second compartment 26 and into the conditioned space is at a temperature equal to or greater than the outdoor air temperature. In other words, outdoor air is drawn into the plenum 102, drawn into the second compartment 26 and discharged to the conditioned space 20 without passing through a heat exchanger for cooling the outdoor air. The direction of the outflow 91b from the second compartment 26 is substantially perpendicular to the direction of the inflow 91a to the second compartment 26.

The first compartment 22 and the second compartment 26 are enclosed on the top by a fresh air cover 94 having a fresh air inlet 98. The fresh air inlet 98 includes a plurality of elongated openings that allow fresh outdoor air from outside of the bus 18 to enter a plenum 102 inside the temperature control unit 10. A housing, generally indicated with the numeral 100 and including the fresh air cover 94, defines the plenum 102. The plenum 102 is a space inside the housing 100 that serves as a holding chamber for air that is to be distributed to the conditioned space 20. The fresh outdoor air enters the first and second compartments 22, 26 from the plenum 102 by way of the first and second compartment inlets 54, 74 and the first and second compartment dampers 58, 78 positioned inside the temperature control unit 10 adjacent the plenum 102. In other constructions, the fresh air inlet 98 may include one or more openings of any shape and size. In yet other constructions, the first and second compartment inlets 54, 74 and the first and second compartment dampers 58, 78 may be positioned in the cover 94 in direct communication with fresh outdoor air for the direct passage of fresh outdoor air into the first and second compartments 22, 26.

The inflow of fresh outdoor air into the plenum 102 and into the first compartment 22 and the second compartment 26 is controlled by the positions of the first and second compartment dampers 58, 78 and by the speed of the first and second blowers 46, 50. When the dampers 58, 78 are closed, the inflow of air into the first and second compartments 22, 26 is minimal or non-existent. When the blowers 46, 50, 66, 70 are not operating, the inflow of air into the first and second compartments 22, 26 is minimal or non-existent. Preferably, the blowers 46, 50, 66, 70 do not operate when the dampers 58, 78 are closed. Furthermore, the outflow of air from the first and second compartments 22, 26 into the conditioned space 20 is also minimal or non-existent when the inflow is minimal or non-existent. When the blowers 46, 50, 66, 70 are operating, the inflows and outflows of air increase with increasing speed of the blowers 46, 50, 66, 70 and decrease with decreasing speed of the blowers 46, 50, 66, 70. Preferably, the dampers 58, 78 are at least partially open when the blowers 46, 50, 66, 70 are operating. The inflow and outflow also increase as the dampers 58, 78 are moved to a more open position and decrease as the dampers 58, 78 are moved to a less open position.

Also positioned inside the temperature control unit 10 is an evaporator compartment inlet 106 and an evaporator compartment damper 110. The evaporator compartment inlet 106 is positioned between the plenum 102 and the evaporator compartment 30. The evaporator compartment 30 is positioned adjacent the first compartment 22, the second compartment 26 and the plenum 102 and also adjacent the condenser compartment 38 at an opposite end. The evaporator compartment inlet 106 provides a passage for fresh outdoor air into the evaporator compartment 30 from the plenum 102. The evaporator compartment damper 110 includes a moveable plate 112 to adjust the inflow of air to the evaporator compartment 30 through the evaporator compartment inlet 106. A third dust filter 114 is positioned within or adjacent the evaporator compartment inlet 106 to filter the inflow of air into the evaporator compartment 30.

Air enters the evaporator compartment 30 from the plenum 102 by way of the evaporator compartment inlet 106 and the evaporator compartment damper 110, as indicated generally by arrows 115a. The air flows around the evaporator 34 and is cooled by the evaporator 34. The cooled air exits the evaporator compartment 30 by way of an evaporator compartment outlet 118 and is directed into a bus duct (not shown) and into the conditioned space 20. The outflow of air is indicated generally by arrows 115b. The cooled air is mixed with fresh outdoor air from the first compartment outlet 62 and the second compartment outlet 90 in the bus duct (not shown), if the outflow of fresh outdoor air is present.

The inflow and outflow of air in the evaporator compartment 30 depends on the evaporator blower and the evaporator compartment damper 110. Air enters the evaporator compartment 30 from the plenum 102 by way of the evaporator compartment inlet 106 and the evaporator compartment damper 110, as indicated generally by arrows 115a. When the evaporator blower is not operating, the inflow of air into the evaporator compartment 30 is minimal or non-existent. The evaporator compartment damper 110 is preferably closed when the evaporator blower is not operating. When the evaporator blower is operating and the evaporator compartment damper 110 is at least partially open, the inflow and outflow increases with increasing speed of the evaporator blower and decreases with decreasing speed of the evaporator blower.

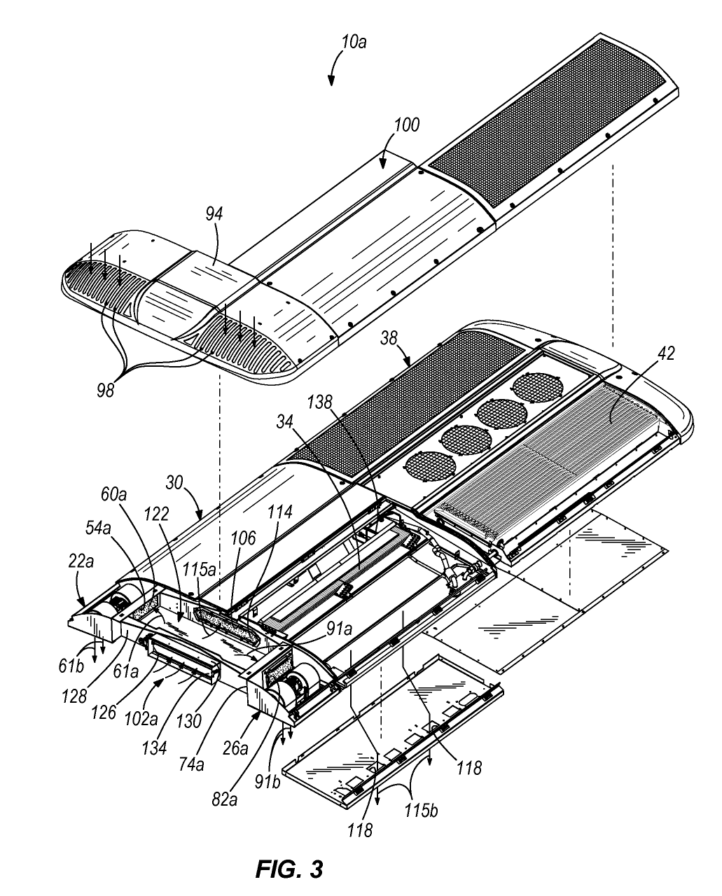

A second construction of the temperature control unit 10 is illustrated in FIG. 3 and is generally indicated with the numeral 10a. The same reference numerals are used for individual components that are unchanged from the construction of FIG. 2, and a successive letter, such as “a”, is appended to reference numerals referring to structure that exists in both the first and the second constructions but that is changed with respect to the first construction. The first compartment 22 and the second compartment 26 are enclosed on the top by the fresh air cover 94 having the fresh air inlet 98. The fresh air inlet 98 includes a plurality of elongated openings that allow fresh outdoor air from outside of the bus 18 to enter a plenum 102a inside the temperature control unit 10a. The fresh outdoor air enters an intermediate plenum 122 from the plenum 102a by way of an intermediate plenum inlet 126 positioned on a partition 128 inside the temperature control unit 10a adjacent the plenum 102a. The intermediate plenum 122 is separated from the plenum 102a by the partition 128. An intermediate plenum damper 130 is coupled to the intermediate plenum inlet 126 and includes a moveable plate 134 for adjusting the inflow of air into the intermediate plenum 122. In other constructions, the intermediate plenum inlet 126 may be positioned in the cover 94 in direct communication with fresh outdoor air for the direct passage of fresh outdoor air into the intermediate plenum 122.

In the construction of FIG. 3, the first and second compartment inlets 54, 74, and dust filters 60, 82 are shifted slightly with respect to the blowers 46, 50, 66, 70, toward the evaporator compartment 30. Thus, the first and second compartment inlets and dust filters are referenced with the numerals 54a, 74a, 60a, 82a in FIG. 3. Furthermore, the first and second compartments are referenced with the numerals 22a, 26a. The shift is to accommodate the division of the plenum 102a and the intermediate plenum 122. In this construction, there are no dampers coupled to the first and second compartment inlets 54a, 74a or to the evaporator compartment inlet 106. The first and second compartment inlets 54a, 74a and the evaporator compartment inlet 106 are positioned downstream of the intermediate plenum inlet 126 and the intermediate plenum damper 130.

In the construction of FIG. 3, the inflow of air into the temperature control unit 10a is controlled by the intermediate plenum damper 130. The inflow of air into the first and second compartments 22a, 26a depends on the blowers 46, 50, 66, 70, as the first and second compartment inlets 54, 74 are without dampers. When the blowers 46, 50, 66, 70 are not operating, the inflow of air into the first and second compartments 22a, 26a is minimal or non-existent. Furthermore, the outflow of air from the first and second compartments 22a, 26a into the conditioned space 20 is also minimal or non-existent. When the blowers 46, 50, 66, 70 are operating, the respective inflows and outflows of air increase with increasing speed of the blowers 46, 50, 66, 70 and decrease with decreasing speed of the blowers 46, 50, 66, 70. Similarly, the inflow and outflow of air in the evaporator compartment 30 depends on the evaporator blower as the evaporator compartment inlet 106 is without a damper. Air enters the evaporator compartment 30 from the intermediate plenum 122 by way of the evaporator compartment inlet 106, as indicated generally by arrows 115a. When the evaporator blower is not operating, the inflow of air into the evaporator compartment 30 is minimal or non-existent. When the evaporator blower is operating, the inflow and outflow increases with increasing speed of the evaporator blower and decreases with decreasing speed of the evaporator blower.

The evaporator compartment inlet 106 is positioned between the intermediate plenum 122 and the evaporator compartment 30. The evaporator compartment 30 is positioned adjacent the first compartment 22, the second compartment 26 and the intermediate plenum 122 and also adjacent the condenser compartment 38.

It is to be understood that in other constructions, the first and second compartments 22, 26 may be separate from the temperature control unit 10 and effectively define a second temperature control unit. That is, the first temperature control unit would include the evaporator and condenser compartments 30, 38, and the second temperature control unit would include the first and second compartments 22, 26 or 22a, 26a, the plenum 102 or 102a and the intermediate plenum 122, if applicable. The first and second temperature control units could be mounted to the vehicle 18 at different locations. Furthermore, each of the first and second compartments 22, 26 could be separate. Each of the first and second compartments 22, 26 could have separate plenums and be mounted to the vehicle 18 at different locations.

A control module 138 is positioned in the evaporator compartment 38 to control the positions of the dampers 58, 78, 110 (in the construction illustrated in FIG. 2) and 130 (in the construction illustrated in FIG. 3) and to control the speed of the first and second compartment blower motors 52, 86 and the evaporator blower. An operator control module (not shown) is positioned in the driver's cab of the bus 18 and allows the operator to control the temperature control unit 10. For example, the operator may enter a setpoint temperature that is a desired temperature within the conditioned space 20. The operator control module is coupled to the control module 138, which adjusts the positions of the dampers 58, 78, 110 and 130, the speed of the first and second compartment blower motors 52, 86 and the evaporator blower, and the operation of the air conditioning system including whether the compressor (not shown) is on or off, in order to reach or maintain the setpoint temperature.

A first temperature sensor (not shown) is positioned outside the bus 18 to measure an outdoor ambient temperature of fresh air outside of the bus 18. A second temperature (not shown) is positioned inside the conditioned space 20 to measure a cabin temperature of the conditioned space 20. The control module 138 compares the outdoor ambient temperature to the cabin temperature and the setpoint temperature to determine whether the outdoor ambient temperature is cooler than the cabin temperature and the setpoint temperature.

If the outdoor ambient temperature is lower than the cabin temperature or the setpoint temperature, then the control module 138 operates blowers 46, 50, 66, 70 by operating the blower motors 52, 86 to blow outdoor air through the first and second compartments 22, 26 and into the conditioned space 20. All or a part of the cooling capacity comes from fresh air. Preferably, the blowers 46, 50, 66, 70 are operated at a high speed. Furthermore, the control module 138 opens the dampers 58, 78 to allow a first portion of outdoor air to pass through the respective compartment 22, 26 into the conditioned space 20. A second portion of outdoor air may simultaneously enter the evaporator compartment 20 by way of the evaporator compartment inlet 106 and the evaporator compartment damper 110 to be cooled by the evaporator 34 and directed to the conditioned space 20 by the evaporator blower.

If the outdoor ambient temperature is lower than the cabin temperature or the setpoint temperature by a predetermined amount, the control module 138 prevents the air conditioner from cooling the conditioned space 20. The predetermined amount is an amount such that the capacity of the fresh outdoor air is enough to keep the cabin temperature close to the setpoint temperature without using the air conditioner. In this case, all of the cooling capacity comes from fresh outdoor air. Preferably, the control module 138 shuts off the compressor (not shown), effectively shutting off the air conditioner to prevent the air conditioner from cooling the conditioned space 20. The control module 138 may also or alternatively close the evaporator compartment damper 110 and/or shut off the evaporator blower to effectively shut off the air conditioner to prevent the air conditioner from cooling the conditioned space 20. Other means may also be employed.

The control module 138 may also vary the speed of the blower motors 52, 86 (and thus the blowers 46, 50, 66, 70) depending on the difference between the outdoor ambient temperature and the cabin temperature or the setpoint temperature. If the outdoor ambient temperature is higher than the cabin temperature and the setpoint temperature, the control module 138 runs the blower motors 52, 86 (and thus the blowers 46, 50, 66, 70) at a low speed to direct a first portion of outdoor air to the conditioned space 20 to maintain air quality, or shuts them off. Furthermore, the air conditioning system runs when the outdoor ambient temperature is higher than the cabin temperature and the setpoint temperature. A second portion of outdoor air enters the evaporator compartment 20 by way of the evaporator compartment inlet 106 and the evaporator compartment damper 110 to be cooled by the evaporator 34 and directed to the conditioned space 20 by the evaporator blower.

Furthermore, when the outdoor ambient temperature is higher than the cabin temperature and the setpoint temperature, and with respect to the first construction of the temperature control system 10, the first and second compartment dampers 58, 78 are open when the blowers 46, 50, 66, 70 are running Conversely, the first and second compartment dampers 58, 78 are closed when the blowers 46, 50, 66, 70 are not running The blowers 46, 50, 66, 70 are shut off when the outdoor ambient temperature is higher than the cabin and setpoint temperatures by a predetermined amount to prevent a large loss in cooling capacity. Similarly, the evaporator compartment damper 110 is closed when the outdoor ambient temperature is higher than the cabin and setpoint temperatures by a predetermined amount to prevent a large loss in cooling capacity. In this case, the evaporator compartment 30 receives and cools only return air from the conditioned space 20.

With respect to the second construction of the temperature control system 10a, when the outdoor ambient temperature is higher than the cabin temperature and the setpoint temperature the intermediate plenum damper 130 is open when the blowers 46, 50, 66, 70 are running. When the blowers 46, 50, 66, 70 are not running, however, the intermediate plenum damper 130 may be open or completely closed depending on whether fresh air is desired in the conditioned space 20 to improve air quality. In some instances, the outdoor ambient temperature may be too high and may affect the cooling capacity of the system 10 too greatly. In such instances, the intermediate plenum damper 130 is completely closed to prevent warmer outdoor air from entering the conditioned space. In such instances, only return air is received and cooled by the evaporator 34.

In other constructions, the flow of fresh outdoor air into the conditioned space 20 can be controlled manually.

Thus, the invention provides, among other things, a temperature control system 10, 10a that effectively utilizes the cooling capacity of fresh outdoor air. Various features and advantages of the invention are set forth in the following claims.

What is claimed is:

1. A rooftop temperature control unit for a vehicle having a conditioned space, the rooftop temperature control unit comprising:
a housing defining a plenum and including an air inlet, the plenum configured to receive an inflow of outdoor air from outside of the vehicle through the air inlet, the outdoor air defining an outdoor air temperature;
a heat exchanger assembly coupled to the housing and in fluid communication with the plenum, the heat exchanger assembly configured to receive a first portion of the outdoor air from the plenum, to cool the first portion to a temperature below the outdoor air temperature, and to discharge the cooled first portion into the conditioned space; and
a blower coupled to the housing and in fluid communication with the plenum, the blower configured to receive a second portion of the outdoor air from the plenum and to discharge the second portion into the conditioned space at a temperature equal to or greater than the outdoor air temperature.

2. The rooftop temperature control unit of claim 1, wherein the blower can be operated at a plurality of non-zero speeds.

3. The rooftop temperature control unit of claim 1, further comprising a controller that operates the blower dependent upon a comparison of a cabin temperature of the conditioned space and the outdoor air temperature.

4. The rooftop temperature control unit of claim 3, wherein the controller operates the blower at a first non-zero speed when the outdoor air temperature is colder than the cabin temperature.

5. The rooftop temperature control unit of claim 1, further comprising a controller that operates the blower dependent upon a desired setpoint temperature of the conditioned space, a measured temperature of the conditioned space, and the outdoor air temperature.

6. The rooftop temperature control unit of claim 5, wherein the controller operates the blower at a first non-zero speed when the measured outdoor air temperature is colder than at least one of the desired setpoint temperature and the measured temperature of the conditioned space.

7. The rooftop temperature control unit of claim 6, wherein the controller operates the blower at a second speed lower than the first non-zero speed when the outdoor air temperature is warmer than the desired setpoint temperature and the measured temperature of the conditioned space.

8. The rooftop temperature control unit of claim 1, wherein the housing includes a first compartment in fluid communication with the plenum and containing the heat exchanger assembly, a second compartment in fluid communication with the plenum and containing the blower, a first damper disposed between the plenum and the first compartment and configured to adjust the inflow of the first portion into the first compartment, and a second damper disposed between the plenum and the second compartment and configured to adjust the inflow of the second portion into the second compartment.

9. The rooftop temperature control unit of claim 8, further comprising a second blower coupled to the housing and in fluid communication with the plenum, the blower configured to receive a third portion of the outdoor air from the plenum and to discharge the third portion into the conditioned space at a temperature equal to or greater than the outdoor air temperature, and wherein the housing includes a third compartment in fluid communication with the plenum and containing the second blower, and a third damper disposed between the plenum and the third compartment and configured to adjust the inflow of the third portion into the third compartment.

10. The rooftop temperature control unit of claim 1, wherein the housing includes a first compartment in fluid communication with the plenum and containing the heat exchanger assembly, a first inlet disposed between the plenum and the first compartment, a second compartment in fluid communication with the plenum and containing the blower, a second inlet disposed between the plenum and the second compartment, and a damper disposed upstream of the plenum for adjusting the inflow of outside air into the plenum, wherein the first inlet and the second inlet are downstream of the damper.

11. The rooftop temperature control unit of claim 10, further comprising a second blower coupled to the housing and in fluid communication with the plenum, the blower configured to receive a third portion of the outdoor air from the plenum and to discharge the third portion into the conditioned space at a temperature equal to or greater than the outdoor air temperature, and wherein the housing includes a third compartment in fluid communication with the plenum and containing the second blower, a third inlet disposed between the plenum and the third compartment, wherein the third inlet is downstream of the damper.

12. The rooftop temperature control unit of claim 1, wherein the blower is configured to discharge the second portion into the conditioned space without passing the second portion through a heat exchanger.

13. A method of operating a rooftop temperature control unit for a vehicle having a conditioned space, the method comprising:
receiving an inflow of outdoor air from outside of the vehicle through an air inlet of a housing and into a plenum defined by the housing;
receiving with a heat exchanger assembly a first portion of the outdoor air from the plenum;
cooling with the heat exchanger assembly the first portion to a temperature below an outdoor air temperature;
discharging with the heat exchanger assembly the cooled first portion into the conditioned space;
receiving with a blower a second portion of the outdoor air from the plenum; and
discharging with the blower the second portion into the conditioned space at a temperature equal to or greater than the outdoor air temperature.

14. The method of claim 13, further comprising:
measuring the outdoor air temperature;
measuring a cabin temperature of air in the conditioned space;
comparing the outdoor air temperature to at least one of the cabin temperature and the setpoint temperature; and
operating the blower at a first non-zero speed when the outdoor air temperature is lower than one of the cabin temperature and the setpoint temperature.

15. The method of claim 13, further comprising operating the blower at a second speed lower than the first non-zero speed when the outdoor air temperature is higher than one of the cabin temperature and the setpoint temperature.

16. The method of claim 13, further comprising stopping the heat exchanger assembly from cooling the first portion when the outdoor ambient temperature is lower than one of the cabin temperature and the setpoint temperature.

17. The method of claim 13, further comprising:
opening a damper of the housing;
receiving the inflow of outdoor air from outside of the vehicle through the damper and into the plenum.

18. The method of claim 13, further comprising:
opening a first damper of the housing;
receiving with the heat exchanger assembly the first portion from the plenum through the first damper;
opening a second damper of the housing; and
receiving with the blower the second portion from the plenum through the second damper.

19. The method of claim 13, further comprising controlling a speed of the blower between a plurality of non-zero speeds depending on a difference between the outdoor air temperature and one of a cabin temperature and a setpoint temperature.

20. The method of claim 13, discharging with the blower the second portion into the conditioned space without passing the second portion through a heat exchanger.
